(19) United States
(12) Patent Application Publication
(10) Pub. No.: US 2012/0007996 A1
(43) Pub. Date: Jan. 12, 2012

(54) Method and Apparatus for Imaging

(75) Inventor: Radu Ciprian Bilcu, Tampere (FI)

(73) Assignee: NOKIA CORPORATION, Espoo (FI)

(21) Appl. No.: 12/981,289

(22) Filed: Dec. 29, 2010

Related U.S. Application Data
(60) Provisional application No. 61/291,142, filed on Dec. 30, 2009.

(51) Int. Cl. H04N 5/228

(52) U.S. Cl. 348/208.2; 348/208.4; 348/E05.065

(57) ABSTRACT

There is disclosed a method and apparatus for setting imaging parameters. Information of several images of a scene is received. The images are captured with different exposure times. Also information of motion of the apparatus is received. On the basis of the motion of the apparatus at least one of the exposure times is estimated.

### TECHNICAL FIELD

The invention relates to the area of capturing one or more images such as single image capturing and multiframe image capturing. In the case of multiframe image capturing, several images, of the same scene, are captured.

### BACKGROUND INFORMATION

In multiframe imaging several images of the same scene are captured by an imaging device such as a camera or a communication device comprising imaging means. Different images may be captured with different settings and then used to obtain a single output image. Depending on the targeted applications and on the distortions addressed the input images might have different focus settings and different exposure times and/or analog gains. Images captured with and without using flash can be combined into one output image, to obtain a result with higher visual quality.

The purpose of the multiframe imaging is to provide an output image having better quality than what a single image capturing process could produce. For example, the imaging device can sequentially take two, three or more images and combine these images into a single output image. The imaging device may use different imaging parameters when it takes the different images so that each image is captured with different settings.

Among different multiframe imaging applications the so called high dynamic range (HDR) approach is probably studied more than other multiframe imaging applications. In this application, several images, captured with different exposure times, are combined into one output image. The reason for capturing and combining several, differently exposed, images is the fact that, many times, the captured scene may have a very high dynamic range, which is much higher than the dynamic range of the imaging sensor of the imaging device. In this case, if a single image is captured, some parts of the image will appear too dark while other parts of the image may be too bright or even saturated. In the multiframe approach, the dark regions of the scene will be better represented in the input images captured with larger exposure times while the very bright objects will be better seen in the short exposed images. By combining these images, it is possible to obtain an output image in which more of the scene objects are visible compared to a single image.

In the case of the high dynamic range multiframe approach one aspect to be taken into account is the selection of the exposure times used to capture the input images. For instance, if only images captured with long exposure time are used, the bright parts of the scene will not be correctly represented in the output image. Another drawback is that motion blur may be present in images which have been captured with relatively long exposure times. This happens due to objects which may move in the scene between different image captures or due to a possible motion of the imaging device during the image exposure. These situations are illustrated in FIG. 1 as follows. When one image has been captured an object is located at a location marked with a circle O. Due to the movement of the object it is located at another location marked with a dotted circle O′ in FIG. 1 when another image has been captured. The possible movement of the imaging device D may affect a change in the scene which an imaging sensor of the imaging device sees. The scene is illustrated with pair of dotted lines V-V and V′-V′ in which the first pair V-V illustrates the scene when the imaging device D is in one location and the second pair V′-V′ illustrates the scene when the imaging device D has moved into another location. It can be seen that the two scenes in this example are slightly different which may cause blur in the captured images.

The example of FIG. 1 can also be used to clarify some situations which may cause blur in a single image capturing case. The object O can be located at the location marked with the circle O when the image capturing starts and at the other location marked with the dotted circle O′ when the image capturing stops. Respectively, possible movement of the imaging device D may affect a change in the scene which an imaging sensor of the imaging device sees during capturing the image if the movement is large enough during the exposure time. The first pair V-V illustrates the scene when the imaging device D begins to capture an image and the second pair V′-V′ illustrates the scene when the imaging device D stops capturing the image. It can be seen that the two scenes in this example are slightly different which may cause blur in the captured image.

From this simple example, it can be seen that the selection of the exposure times of the input images may play a meaningful role in the high dynamic range multiframe application and also in single image capturing application. Selecting the input exposure times is usually called bracketing when the selection is made manually e.g. by the user of the imaging device, or autobracketing when the selection is automatic i.e. made by the imaging device.

Due to the motion blur effect, the selection of the largest exposure time is an important part of the bracketing/autobracketing step.

### SUMMARY OF SOME EXAMPLE EMBODIMENTS

The present invention discloses a method for setting imaging parameters for multiframe images. In some example embodiments information from a motion sensor, such as an accelerometer and/or a compass, is used, possibly in addition to some other approach, in forming the output image.

In an example embodiment the accelerometer and/or compass data are read continuously during the image capturing process. The captured accelerometer and/or compass data are analyzed on the fly and the motion of the device is detected. If fast motion is detected during the image capturing process and a very large exposure time is to be used the device automatically decreases the exposure time in order to eliminate or reduce the motion blur.

The invention can be used in high dynamic range multiframe image capturing as well as in single frame imaging. In the case of single frame imaging the selection of the autoexposure time can be implemented such that the value of the exposure time is limited due to detected motion of the device.

According to a first aspect of the present invention there is provided a method comprising:

receiving information of several images of a scene captured with different exposure times;

receiving information of motion of the device; and

estimating at least one of the exposure times based on the motion of the device.

According to a second aspect of the present invention there is provided a method comprising:

receiving information indicative of a motion of an imaging sensor;

estimating an exposure time based on the motion of the imaging sensor; and
providing control to the imaging sensor for using the estimated exposure time in capturing an image.

According to a third aspect of the present invention there is provided an apparatus comprising:

a first input receiving information of several images of a scene captured with different exposure times;

a second input receiving information of motion of the device; and
a processor for estimating at least one of the exposure times based on the motion of the device.

According to a fourth aspect of the present invention there is provided an apparatus comprising:

an input for receiving information indicative of a motion of an imaging sensor; and

at least one processor and at least one memory including computer program code, the at least one memory and the computer program code configured to, with the at least one processor, cause the apparatus at least to estimate an exposure time based on the motion of the imaging sensor; and providing control to the imaging sensor for using the estimated exposure time in capturing an image.

According to a fifth aspect of the present invention there is provided a computer program product comprising a computer program code configured to, with at least one processor, cause an apparatus to:

receive information of several images of a scene captured with different exposure times;

receive information of motion of the device; and

estimate at least one of the exposure times based on the motion of the device.

According to a sixth aspect of the present invention there is provided a computer program product comprising a computer program code configured to, with at least one processor, cause an apparatus to:

receive information indicative of a motion of an imaging sensor;

estimate an exposure time based on the motion of the imaging sensor; and

provide control to the imaging sensor for using the estimated exposure time in capturing an image.

According to a seventh aspect of the present invention there is provided an apparatus comprising:

means for receiving information of several images of a scene captured with different exposure times;

means for receiving information of motion of the device; and

means for estimating at least one of the exposure times based on the motion of the device.

According to an eighth aspect of the present invention there is provided an apparatus comprising:

means for receiving information indicative of a motion of an imaging sensor; and

means for estimating an exposure time based on the motion of the imaging sensor; and

means for providing control to the imaging sensor for using the estimated exposure time in capturing an image.

### DESCRIPTION OF THE DRAWINGS

In the following the invention will be explained in more detail with reference to the appended drawings, in which

FIG. 1 depicts an example situation of image capturing;

FIG. 2 depicts a device according to an example embodiment of the invention as a simplified block diagram;

FIG. 3 depicts a flowchart of a method of multiframe imaging according to an example embodiment of the invention in which exposure time selection is automatic;

FIG. 4 depicts a flowchart of a method of multiframe imaging according to an example embodiment of the invention in which exposure time selection is manual;

FIG. 5 depicts a flowchart of a method of single frame imaging according to an example embodiment of the invention in which exposure time selection is automatic;

FIG. 6 depicts a flowchart of a method of single frame imaging according to an example embodiment of the invention in which exposure time selection is manual;

FIG. 7 depicts as a simplified diagram an imaging sensor and imaging optics according to an example embodiment of the invention; and

FIG. 8 depicts as a simplified diagram a motion detector according to an example embodiment of the invention.

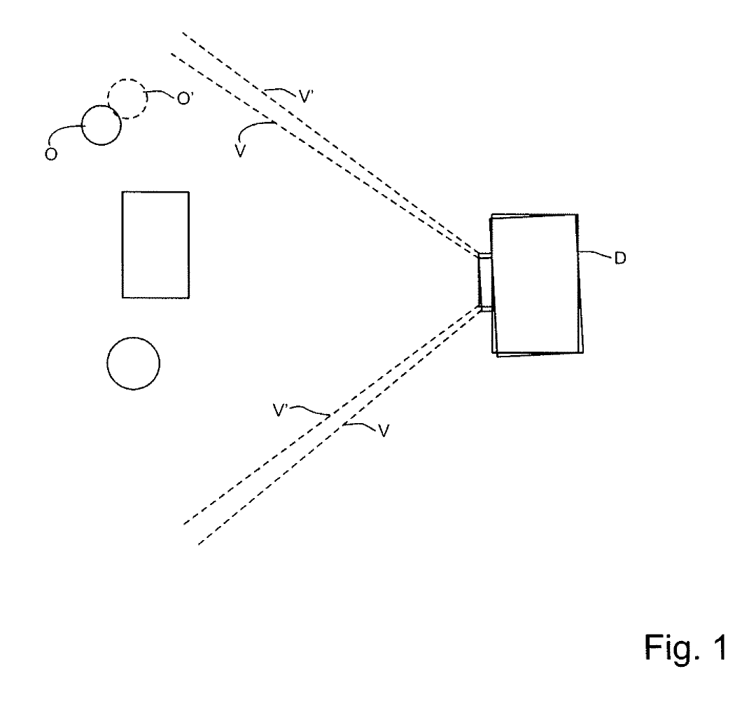

### DETAILED DESCRIPTION OF SOME EXAMPLE EMBODIMENTS

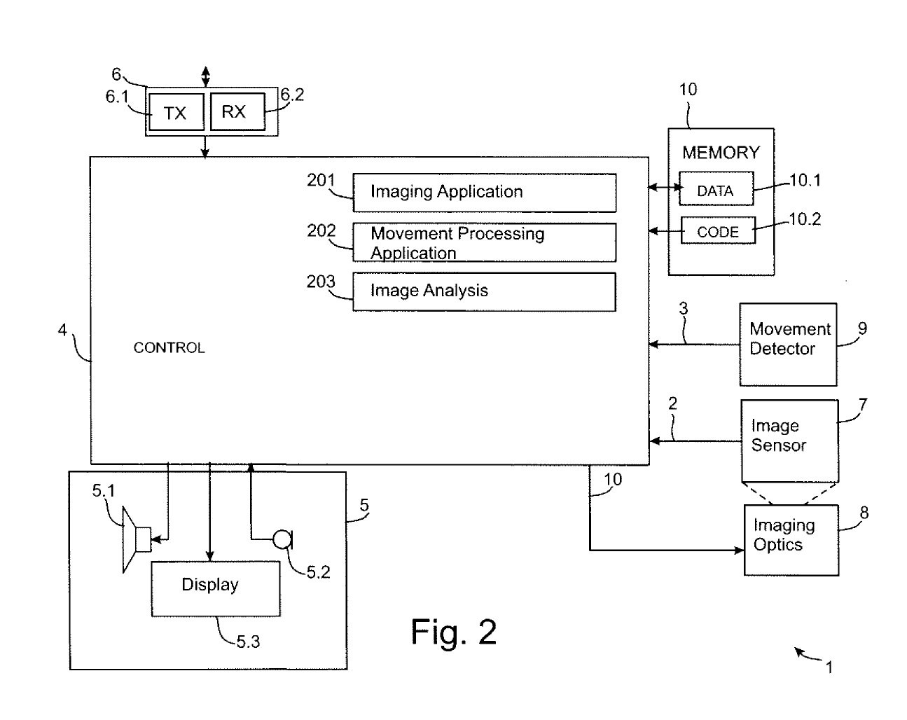

In the following an example embodiment of a device according to an example embodiment of the present invention will be described with reference to FIG. 2. The device 1 can be any apparatus which has at least a first input 2 for inputting imaging information, a second input 3 for inputting motion information and a processor 4 or other controller for processing imaging information and motion information to produce the output image. The device 1 may also comprise user interface 5 for providing audio information by e.g. a loudspeaker 5.1, for inputting audio information by e.g. a microphone 5.2 and for displaying images and other visual information e.g. by a display 5.3. It is also possible that the device 1 comprises a transceiver 6 or other communication means to transmit information by a transmitter 6.1 to another device and/or to receive information by a receiver 6.2 from another device.

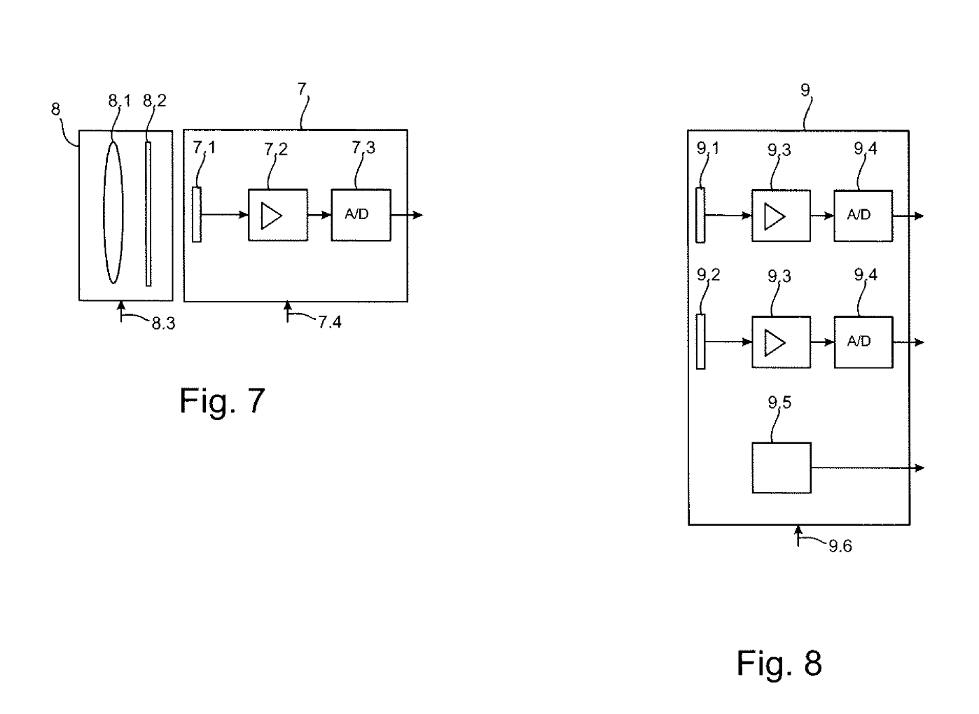

In the example embodiment of FIG. 2 the device further comprises an imaging sensor 7 and imaging optics 8 for taking images, and a motion detector 9 to detect motions of the device 1. FIG. 7 illustrates an example embodiment of the imaging sensor 7 and imaging optics 8. The imaging sensor 7 comprises one or more imaging elements 7.1 which transform light into electrical signals such as electrical charge, voltage or current. The imaging sensor 7 may also comprise one or more amplifiers 7.2 to amplify the signals of the imaging element(s) 7.1, and one or more analog-to-digital converters 7.3 to convert the imaging signals or the amplified imaging signals into digital signals, such as digital samples, if necessary. The imaging sensor 7 may also comprise one or more control inputs 7.4 to control the operating parameters and/or other operation of the imaging sensor 7. For example the gain of the amplifier 7.2 can be controlled by inputting a control signal to the control input 7.4 e.g. by the processor 4.

The imaging optics 8 may comprise one or more lenses 8.1 to focus optical image onto the surface of the imaging element 7.1. The imaging optics 8 may also comprise a shutter 8.2 to allow light (i.e. the optical image) passing onto the surface of the imaging element 7.1 during capturing the image and to prevent light passing onto the surface of the imaging element 7.1 when an image is not captured. In other words, the exposure time can be set by controlling the operation of the shutter 8.2. It should be noted, however, that there may be other ways to set the exposure time during imaging than using the shutter 8.2.

The imaging optics 8 may be controlled by entering a control signal to a control input 8.3 of the imaging optics.

The motion detector 9 may comprise an accelerometer 9.1 and/or a compass 9.2 which can be used to measure the motion and/or the acceleration of the device 1 and the direction of the motion of the device 1 and/or the heading of the device 1. In some embodiments the motion detector 9 may comprise a positioning sensor 9.5 such as a positioning receiver which receives signals from transmitters of a positioning system such as a global positioning system or a local area network. FIG. 8 illustrates an example embodiment of the motion detector 9. The motion detector 9 may also comprise one or more amplifiers 9.3 to amplify the measurement signals of the accelerometer 9.1 and/or the compass 9.2, and one or more analog-to-digital converters 9.4 to convert the measurement signals or the amplified measurement signals into digital signals, such as digital samples, if necessary. The motion detector 9 may also comprise one or more control inputs 9.6 to control the operating parameters and/or other operation of the motion detector 9. For example, motion information may be read by entering a command via the control input 9.6 of the motion detector 9 to the analog-to-digital converter 9.4. There is also some memory 10 in the device 1 of FIG. 2. The memory 10 may comprise storage elements for storing data 10.1 and storage elements for storing program code(s) 10.2.

The processor 4 can then use information of the motion, heading and/or changes of the position of the device 1 to determine whether the device 1 has moved or changed its position between capturing of different input images so that blur may occur between successive images captured by the imaging sensor 7.

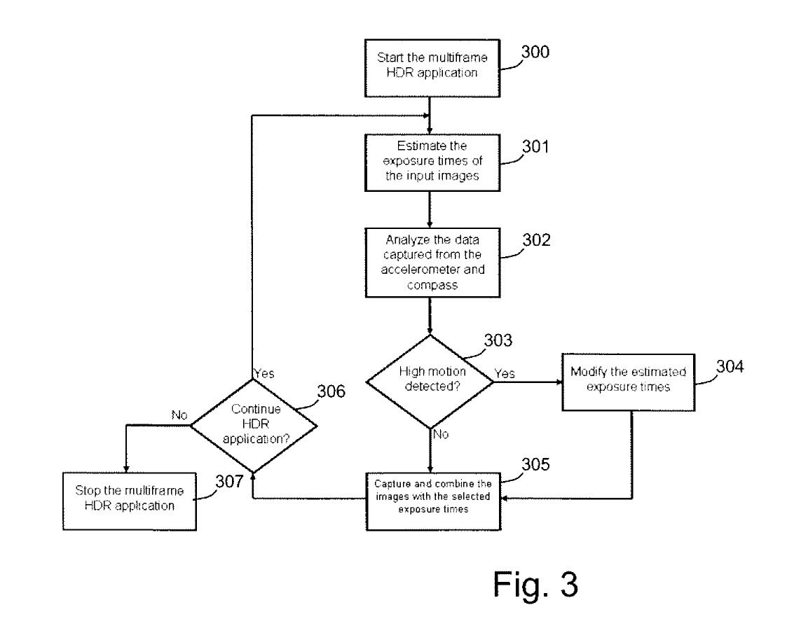

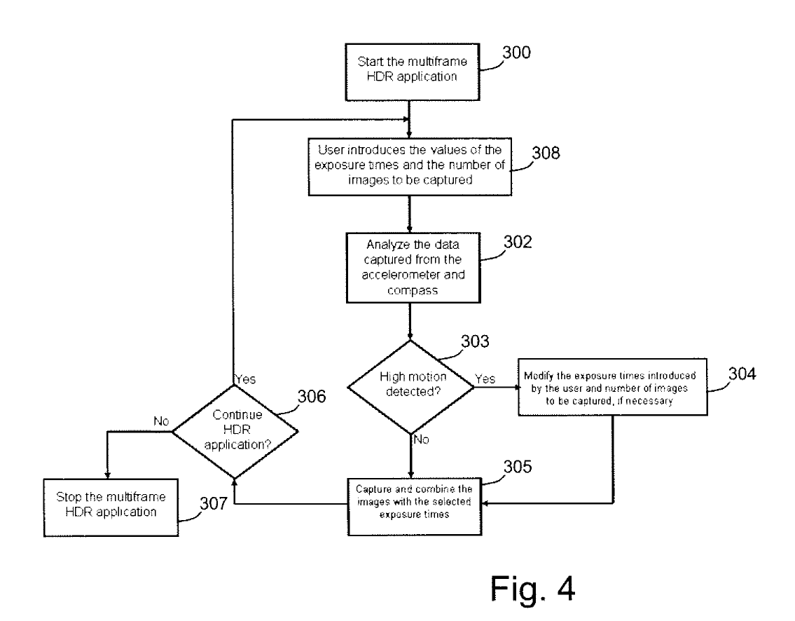

The present invention can be utilized in both multiframe and single frame image capturing applications for selecting the exposure time of the recorded images. In FIG. 3 the high dynamic range multiframe imaging with automatic bracketing is described while in FIG. 4 the high dynamic range multiframe imaging with manual selection of the exposure times is illustrated.

In the following an example embodiment of the method according to the present invention will be described in more detail with reference to the device of FIG. 2 and the flow diagram of FIGS. 3 and 4. An imaging application 201 is started 300 if it is not already running. The imaging application 201 comprises program code which when executed by the processor 4 causes the device 1 to perform operations to capture multiple images and to process them appropriately. It is also possible that the imaging application 201 and/or other processes and applications of the device 1 are implemented as a chip or other circuitry or as a combination of program code and circuitry.

When the imaging application 201 is started, the device also starts to collect data from the motion detector 9. This can be accomplished by e.g. so that the processor 4 receives via the second input 3 measurement data relating to the motions and changes of the position of the device 1 from the motion detector 9. The program code may comprise instructions for receiving and processing the measurement data. This kind of a software module is illustrated with the reference numeral 202 in FIG. 2.

When some amount of intermediate images (for example viewfinder or sensor images) have been captured, they are analyzed 301 by e.g. the processor executing an analysis application 203. The analysis can be performed e.g. after two or three images have been captured but the number of images can also be different from that. In the analysis, the range of the light reflected from the scene is estimated and the number of images to be captured and their corresponding exposure times are automatically selected. Alternatively, as depicted with block 308 in FIG. 4, the user can manually select the number of captured images and/or their corresponding exposure times.

An example embodiment of the automatic selection of exposure times will be explained later in this application.

In block 302 the motion data, collected from the motion detector 9 is analyzed. The analysis is done to detect 303 if there is a motion of the device 1 which might introduce motion blur into the captured images.

If such a motion of the device 1 is detected or any motion that could introduce blur, the values of the exposure times, that have been estimated are reduced such that the blur introduced by the motion of the device 1 may be reduced or attenuated 304. In another embodiment of the invention, only some of the estimated exposure times are reduced. Alternatively, the number of captured images will be reduced if some exposure times will become very close after decreasing. The factors by which the exposure times are reduced can be predefined and stored into the memory 10 of the device 1.

When the values of the exposure times have been estimated and corrected, if necessary, several images are captured with exposure times estimated as in steps 301 to 304. The captured images are then combined 305 into one output image.

In block 306 it is determined whether the image capturing will be continued or stopped. If the user wants to continue the high dynamic range multiframe image capturing, the process is started from the second processing step 301 or stopped 307 otherwise.

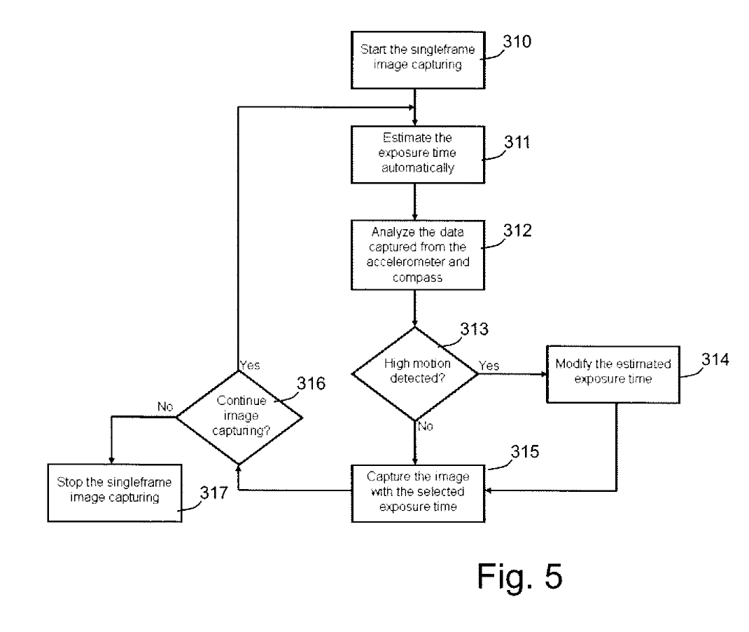

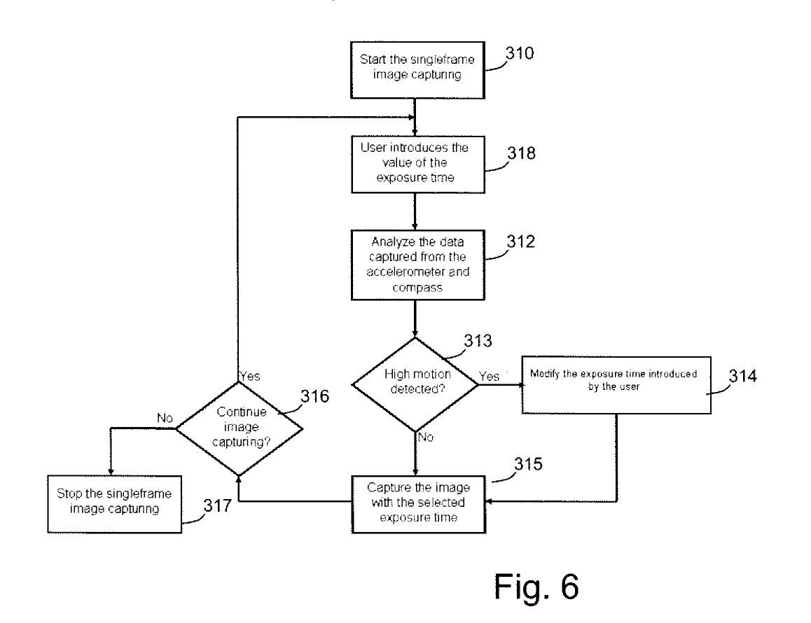

In the following another example embodiment of the method according to the present invention will be described in more detail with reference to the device of FIG. 2 and the flow diagram of FIGS. 5 and 6. This embodiment relates to a single frame imaging in which the exposure time is selected either automatically or manually.

An imaging application 201 is started 310 if it is not already running. The imaging application 201 comprises program code when executed by the processor 4 causes the device 1 perform operations to capture images and process them appropriately. When the imaging application 201 is started, the device also starts to collect data from the motion detector 9.

The exposure time may be selected automatically (block 311 in FIG. 5). Alternatively, as depicted with block 318 in FIG. 6, the user can manually select the exposure time.

In block 312 the motion data, collected from the motion detector 9 is analyzed. The analysis is done to detect 313 if there is a motion of the device 1 which might introduce motion blur into the captured images.

If such a motion of the device 1 is detected or any motion that could introduce blur, the value of the exposure time that have been estimated is modified e.g. by reducing the exposure time such that the blur introduced by the motion of the device 1 may be reduced or attenuated 314. The factors by which the exposure time is reduced can be predefined and stored into the memory 10 of the device 1.

When the value of the exposure time has been estimated and corrected, if necessary, an image is captured 315 with exposure time estimated as in steps 311 to 314.

In block 316 it is determined whether the single image capturing will be continued or stopped. If the user wants to continue the single image capturing, the process is started from the second processing step 311 or stopped 317 otherwise.

In the following an example embodiment of the automatic selection 301, 311 of the exposure times will be described. However, there are other alternative ways to do the automatic selection of the exposure times.

The maximum “exp_max” and minimum “exp_min” allowed values of the exposure time value are initialized. Then, one viewfinder image is captured using an automatic selection for the exposure time value. The viewfinder image is possibly captured with a smaller resolution (e.g. 240×320 resolution) than when taking the image(s) for the final, output image. This viewfinder image is denoted as “Im1”. The method for exposure time selection can be any existing automatic method such as the one which is already implemented in some Nokia camera phones. The value of the exposure time, denoted as “exp1”, is stored into the memory 10. The cumulated histogram of the intensity of image “Im1” is calculated and a mean filter is applied on the histogram. The histogram values that cause a certain percentual modification (e.g. 10%) from both ends (for maximum and minimum values) are taken. These histogram values are denoted with hmin and hmax. Then, one view finder image is captured using the maximum value of the exposure time “exp_max” and new histogram values hmin and hmax are calculated using this image. If the new value of hmax is only a small amount (e.g. less than 4%) smaller than the previous one, the “exp_max” is increased, otherwise “exp_max” is decreased.

Similar steps are done to update “exp_min”. The difference is that “exp_min” is decreased when the new computed value of hmin is only a small amount (e.g. less than 4%) smaller than the previous one, otherwise “exp_min” is increased.

The steps above are repeated until the user press the snapshot button. When the snapshot button is pressed the distances of maximum and minimum exposure time values to the exposure value obtained automatically are computed. If the distances are close, three images are captured but if they are different only the exposure value with the bigger distance value and the automatic exposure value are used. A certain number of consecutive images are captured (e.g. two, three or more) at full resolution using the previously computed exposure times.

It should be mentioned here that the motion of the imaging sensor 7 and/or the imaging optics 8 may cause the motion blur. When the imaging sensor 7 and the imaging optics 8 are connected to or attached with the device 1 the motion of the device 1 may also cause that the imaging sensor 7 and the imaging optics 8 move correspondingly. In that case the motion detector 9 may be attached to the device 1 so that information from the motion detector 9 is indicative of motion of the device 1 and also indicative of the motion of the imaging sensor 7 and the imaging optics 8. However, if the device 1 in which the analysis is performed is separate from the imaging sensor 7 and the imaging optics 8, it may happen that the motion of the device 1 may not be related to the motion of the imaging sensor 7 and imaging optics 8. In such a case it may be better to provide the motion detector 9 in connection with the imaging sensor 7 and/or the imaging optics 8 so that information from the motion detector 9 is indicative of the motion of the imaging sensor 7 and/or the imaging optics 8.

As used in this application, the term ‘circuitry’ refers to all of the following:

(a) to hardware-only circuit implementations (such as implementations in only analog and/or digital circuitry) and

(b) to combinations of circuits and software (computer programs) (and/or firmware), such as: (i) to a combination of processor(s) or (ii) to portions of processor(s)/software (including digital signal processor(s)), software, and memory(ies) that work together to cause an apparatus, such as a mobile phone, a server, a computer, a music player, an audio recording device, etc, to perform various functions) and

(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

The computer programs may be stored in the memory of the device (e.g. a terminal, a mobile terminal, a wireless terminal etc.), for example. The computer program may also be stored in a data carrier such as a memory stick, a CDROM, a digital versatile disk, a flash memory etc.

What is claimed is:

1. A method in a device comprising:
receiving information of several images of a scene captured by an imaging sensor with different exposure times;
receiving information indicative of a motion of the imaging sensor; and
estimating at least one of the exposure times based on the motion of the imaging sensor.

2. A method according to claim 1, wherein the number of captured images is automatically selected based on the detected dynamic range of the scene and motion of the imaging sensor.

3. A method according to claim 1, wherein the motion of the device is detected by at least one of the following:
an accelerometer sensor;
a compass sensor;
a positioning sensor.

4. A method according to claim 1 comprising selecting the exposure times automatically and automatically modifying the exposure times by the device according to the detected motion of the imaging sensor.

5. A method in a device comprising:
receiving information indicative of a motion of an imaging sensor;
estimating an exposure time based on the motion of the imaging sensor; and
providing control to the imaging sensor for using the estimated exposure time in capturing an image.

6. A method according to claim 5, wherein the motion of the imaging sensor is detected by at least one of the following:
an accelerometer sensor;
a compass sensor;
a positioning sensor.

7. A method according to claim 5 comprising selecting the exposure time automatically and automatically modifying the exposure time by the device according to the detected motion of the imaging sensor.

8. An apparatus comprising:
a first input for receiving information of several images of a scene captured by an imaging sensor with different exposure times;
a second input for receiving information of motion of the imaging sensor; and
at least one processor and at least one memory including computer program code, the at least one memory and the computer program code configured to, with the at least one processor, cause the apparatus at least to estimate at least one of the exposure times based on the motion of the imaging sensor.

9. An apparatus according to claim 8, wherein the at least one memory and the computer program code are further configured to, with the at least one processor, cause the apparatus to automatically select the number of captured images based on the detected dynamic range of the scene and motion of the imaging sensor.

10. An apparatus according to claim 8 comprising at least one of the following to detect the motion of the imaging sensor:
an accelerometer sensor;
a compass sensor;
a positioning sensor.

11. An apparatus according to claim 8 wherein the at least one memory and the computer program code are further configured to, with the at least one processor, cause the apparatus to select the exposure times automatically and to automatically modify the exposure times according to the detected motion of the imaging sensor.

12. An apparatus according to claim 8 further comprising an amplifier for amplifying imaging signals captured by the imaging sensor, wherein the at least one memory and the computer program code are further configured to, with the at least one processor, cause the apparatus to automatically modify an analog gain of the amplifier when the exposure time is modified.

13. An apparatus comprising:
an input for receiving information indicative of a motion of an imaging sensor; and
at least one processor and at least one memory including computer program code, the at least one memory and the computer program code configured to, with the at least one processor, cause the apparatus at least to estimate an exposure time based on the motion of the imaging sensor; and providing control to the imaging sensor for using the estimated exposure time in capturing an image.

14. An apparatus according to claim 13 comprising at least one of the following to detect the motion of the imaging sensor:
an accelerometer sensor;
a compass sensor;
a positioning sensor.

15. An apparatus according to claim 13, wherein the at least one memory and the computer program code are further configured to, with the at least one processor, cause the apparatus to automatically select the exposure times and to automatically modify the exposure times according to the detected motion of the imaging sensor.

16. A computer program product stored on a storage medium comprising a computer program code configured to, with at least one processor, cause an apparatus to:
receive information of several images of a scene captured by an imaging sensor with different exposure times;
receive information of motion of the imaging sensor; and
estimate at least one of the exposure times based on the motion of the imaging sensor.

17. A computer program according to claim 16 comprising computer instructions for selecting the number of captured images based on the detected dynamic range of the scene and motion of the imaging sensor.

18. A computer program according to claim 16 comprising computer instructions for receiving information of the motion of the device from at least one of the following:
an accelerometer sensor;
a compass sensor;
a positioning sensor.

19. A computer program according to claim 16 comprising computer instructions for selecting the exposure times automatically and modifying the exposure times according to the detected motion of the imaging sensor.

20. A computer program product stored on a storage medium comprising a computer program code configured to, with at least one processor, cause an apparatus to:
receive information indicative of a motion of an imaging sensor;
estimate an exposure time based on the motion of the imaging sensor; and
provide control to the imaging sensor for using the estimated exposure time in capturing an image.

21. A computer program according to claim 20 comprising computer instructions for receiving information of the motion of the imaging sensor from at least one of the following:
an accelerometer sensor;
a compass sensor;
a positioning sensor.

22. A computer program according to claim 20 comprising computer instructions for selecting the exposure time automatically and for automatically modifying the exposure time by the device according to the detected motion of the imaging sensor.

23. An apparatus comprising:
means for receiving information of several images of a scene captured by an imaging sensor with different exposure times;
means for receiving information of motion of the imaging sensor; and
means for estimating at least one of the exposure times based on the motion of the imaging sensor.

24. An apparatus comprising:
means for receiving information indicative of a motion of an imaging sensor; and
means for estimating an exposure time based on the motion of the imaging sensor; and
means for providing control to the imaging sensor for using the estimated exposure time in capturing an image.
